(19) United States
(12) Patent Application Publication
(10) Pub. No.: US 2013/0049697 A1
(43) Pub. Date: Feb. 28, 2013

(54) BATTERY PROTECTION INTEGRATED CIRCUIT ARCHITECTURE

(71) Applicant: Guoxing LI, Sunnyvale, CA (US)

(72) Inventor: Guoxing LI, Sunnyvale, CA (US)

(21) Appl. No.: 13/218,891

(22) Filed: Aug. 26, 2011

(51) Int. Cl. H02J 7/00

(52) U.S. Cl. 320/134

(57) ABSTRACT

A battery charging/discharging apparatus comprising a battery with at least one battery module, a charge transistor and a discharge transistor. The apparatus further comprises an over-voltage/under-voltage protection circuit connected to the battery pack, the charge transistor, and the discharge transistor. The over-voltage/under-voltage protection circuit controls the charging of the battery with the charge transistor and the discharging of the battery with the discharge transistor. The charge transistor is ON and the discharge transistor is OFF when the battery, as determined by the over-voltage/under-voltage protection circuit, is in an under-voltage state. The discharge transistor is switched ON while still in the under-voltage state when a voltage between the charging transistor and the discharge transistor is less than a reference voltage as determined by a charging state comparator, when a charging circuit is charging the battery.

### TECHNICAL FIELD

The present disclosure relates generally to the field of rechargeable batteries and more specifically to the field of battery cell charging and discharging protection circuits.

### BACKGROUND

During the past few decades, there has been an increasing interest in electronic devices, such as power supplies for various applications. The increasing demand for power supplies has resulted in the continuous development of battery packs, e.g., rechargeable battery packs.

A battery pack can consist of multiple battery cells coupled in series. When one of the battery cells is damaged, the lifetime of the battery pack will be shortened. An unbalance between any two of the battery cells can lead to a reduction in battery lifetime. FIG. 1 illustrates a block diagram of a conventional lead-acid battery pack 100. The lead-acid battery pack 100 is generally employed in low cost applications due to its simple structure. Other battery packs can also utilize lithium ion (Li-ion) batteries.

The battery pack 100 can include multiple battery modules 101-104 coupled in series. Each of the battery modules 101-104 can also consist of six battery cells 111-116 and two electrodes 120 and 129.

Each battery cell in a battery pack needs to have its cell voltage individually monitored. Such monitoring can allow for precise battery cell charging and discharge control. Such monitoring protects battery cells from being over-charged or over-discharged when their voltage level is “over-voltage” (OV) or “under-voltage” (UV), respectively. When the voltage of a battery cell, especially lithium ion (Li-ion) battery cells, gets too low, there can potentially be issues, such as internal shorting. Therefore, when the voltage level of a battery cell gets too low, ideally charge/discharge control circuitry will prevent any further charging or discharging. Also, if the voltage output of a battery cells gets too high, further charging of the over-voltage cell should be stopped to prevent the over-voltage cells from suffering damage or burning.

Embodiments following conventional methods for monitoring discharging current and determining a discharge/charge state can make use of a dedicated current sense pin. The embodiments of these conventional methods can have a high system cost, and due to the necessity of using a sense resistor also have decreased efficiency. For example, current conventional embodiments require the use of a large resistor to connect between battery pack terminals (i.e., PACK+/ PACK−) in order to assess a charging or load condition, which may not be acceptable in all situations. Therefore, there is a need to provide a minimum pin count while still providing the required monitoring of charge/discharge conditions to control discharge/charge field effect transistors, as well as avoiding any potential damage to the battery back and associated control circuitry from over-charging, short-circuit or over-temperature conditions, for example.

### SUMMARY OF THE INVENTION

This present invention provides a solution to the challenges inherent in monitoring the charging/discharging of a battery pack while avoiding potential overheating of the charge transistor and the discharge transistor. In one embodiment of the present disclosure, a battery charging/discharging apparatus comprises a battery with at least one battery module, a charge transistor and a discharge transistor. The apparatus further comprises an over-voltage/under-voltage protection circuit connected to the battery pack, the charge transistor, and the discharge transistor. The over-voltage/under-voltage protection circuit controls the charging of the battery with the charge transistor and the discharging of the battery with the discharge transistor.

The charge transistor is ON and the discharge transistor is OFF when the battery, as determined by the over-voltage/under-voltage protection circuit, is in an under-voltage state. The discharge transistor is switched ON while still in the under-voltage state when a voltage between the charging transistor and the discharge transistor is less than a reference voltage as determined by a charging state comparator, when a charging circuit is charging the battery.

The discharge transistor is ON and the charge transistor is OFF when the battery, as determined by the over-voltage/under-voltage protection circuit, is in one of a normal state and an over-voltage state. The charge transistor is switched ON while still in the normal or over-voltage state when a voltage over the discharge transistor is higher than a discharge reference voltage, as determined by a discharging state comparator

In a method according to one embodiment of the present invention, a method for controlling the charging and discharging of a battery pack while protecting the charging transistor and discharging transistor from overheating is disclosed. A method according to the present disclosure includes the steps of: detecting an under-voltage state, turning a charging transistor ON and turning a discharging transistor OFF, wherein the battery pack is charged through the charging transistor, and discharged through the discharging transistor, and charging the battery pack. The method further comprises turning the discharging transistor ON while still in the under-voltage state when a voltage between the charging transistor and the discharging transistor is less than a reference voltage.

The method further comprises detecting one of an over-voltage state and a normal state, and turning a discharge transistor ON and turning a charge transistor OFF. The charge transistor is turned ON while still in the over-voltage state or the normal state when a voltage over the discharge transistor is higher than a discharge reference voltage as determined by a discharging state comparator.

### BRIEF DESCRIPTION OF THE DRAWINGS

The present invention will be better understood from a reading of the following detailed description, taken in conjunction with the accompanying drawing figures in which like reference characters designate like elements and in which:

FIG. 1 illustrates a simplified block diagram of a conventional battery pack;

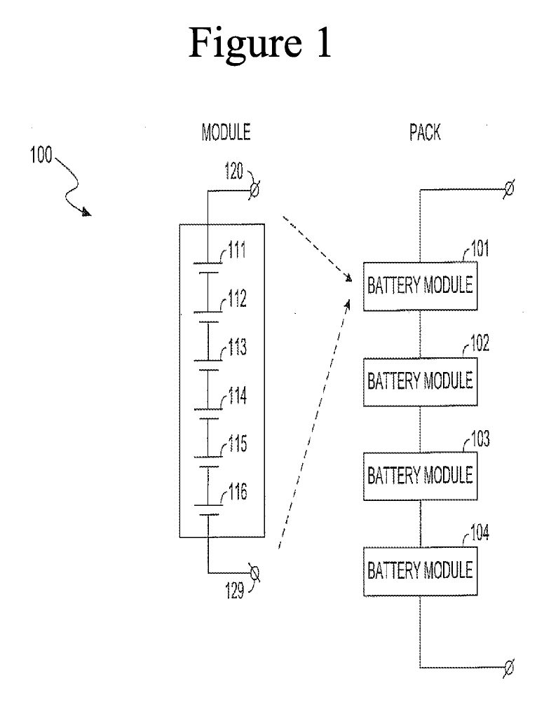

FIG. 2 illustrates a simplified block diagram of a charge/discharge state protection circuit for a battery pack in accordance with an embodiment of the present invention;

FIG. 3 illustrates a simplified block diagram of a charge/discharge state protection circuit for a battery pack in accordance with an embodiment of the present invention;

FIG. 4 illustrates a flow diagram, illustrating the steps to a method in accordance with an embodiment of the present invention; and

FIG. 5 illustrates a flow diagram, illustrating the steps to a method in accordance with an embodiment of the present invention.

### DETAILED DESCRIPTION

Reference will now be made in detail to the preferred embodiments of the present invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of embodiments of the present invention, numerous specific details are set forth in order to provide a thorough understanding of the present invention. However, it will be recognized by one of ordinary skill in the art that the present invention may be practiced without these specific details. In other instances, well-known methods, procedures, components, and circuits have not been described in detail so as not to unnecessarily obscure aspects of the embodiments of the present invention. The drawings showing embodiments of the invention are semi-diagrammatic and not to scale and, particularly, some of the dimensions are for the clarity of presentation and are shown exaggerated in the drawing Figures. Similarly, although the views in the drawings for the ease of description generally show similar orientations, this depiction in the Figures is arbitrary for the most part. Generally, the invention can be operated in any orientation.

### NOTATION AND NOMENCLATURE:

Some portions of the detailed descriptions, which follow, are presented in terms of procedures, steps, logic blocks, processing, and other symbolic representations of operations on data bits within a computer memory. These descriptions and representations are the means used by those skilled in the data processing arts to most effectively convey the substance of their work to others skilled in the art. A procedure, computer executed step, logic block, process, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “ processing” or “accessing” or “ executing” or “ storing” or “rendering” or the like, refer to the action and processes of a computer system, or similar electronic computing device, that manipulates and transforms data represented as physical (electronic) quantities within the computer system's registers and memories and other computer readable media into other data similarly represented as physical quantities within the computer system memories or registers or other such information storage, transmission or display devices. When a component appears in several embodiments, the use of the same reference numeral signifies that the component is the same component as illustrated in the original embodiment.

This present invention provides a solution to the increasing challenges inherent in charging/discharging monitoring and current condition detection in a battery module or pack. Various embodiments of the present disclosure provide efficient charge/discharge state detection as well as over-current detection. As discussed in detail below, there is no dedicated current sense resistor or dedicated sense pin used. The current monitoring, open load detection, and charging conditions are combined into a single pin with any necessary external connections. Further, as described in detail below, when the battery pack is in an under-voltage state and a charging current is applied, the discharge FET (DFET) may be turned ON to prevent the DFET from overheating; and when the battery pack is in an over-voltage state and a discharging current is flowing, the charging FET (CFET) may be turned ON to prevent the CFET from overheating. As further described in detail below, during the under-voltage state, the DFET is periodically turned OFF to monitor the discharge state signal.

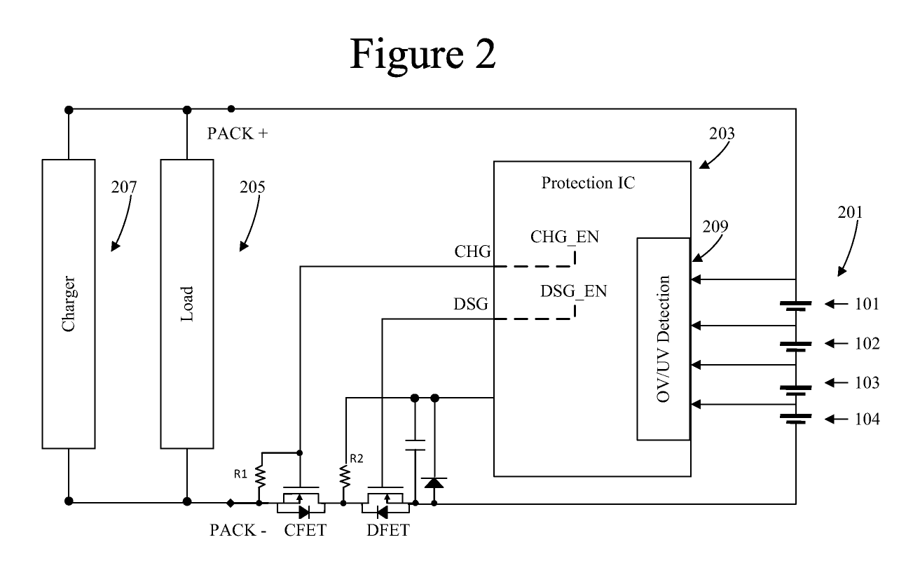

In one exemplary embodiment, as illustrated in FIG. 2, a battery pack 201 comprising a plurality of battery modules 101-104 is connected in parallel with a protection circuit 203 and a load 205. In one exemplary embodiment, the load 205 may be removed from the PACK+/PACK− terminals of the battery pack 201. When there exists an under voltage (UV) state as detected by an over-voltage/under-voltage detection module 209 of the protection circuit 203, a charging enable signal CHG_EN will be high, such that the CHG pin will supply a constant current to turn on a charge transistor (CFET), while the discharge FET (DFET) will be turned off. Furthermore, if a charger 207 is plugged into the PACK+/PACK− terminals, as illustrated in FIG. 2 (in an exemplary embodiment, the load 205 is removed before the charger 207 is connected to the PACK+/PACK− terminals), the battery pack 201 can be charged by the charger 207 through a body diode of the DFET. When the charging current flowing through the DFET is high enough, the power generated through the DFET can potentially over-heat or even damage the DFET. As discussed above and described in detail below, one solution that prevents the DFET from overheating is to turn the DFET ON when in a charging condition.

Similarly, when there exists an over-voltage (OV) state as detected by the over-voltage/under-voltage detection module 209 of the protection circuit 203 in the above exemplary embodiment, a discharge enable signal DSG_EN will be high, such that the DSG pin supplies a signal sufficient to turn on the DFET, while the CFET will be turned off. Furthermore, in one embodiment, if an over-voltage condition has been determined, before the discharge state can be started, the load 205 will be removed. When the battery pack starts to discharge (upon reaching an over-voltage state and the activation of the discharging transistor DFET), a discharging current will begin flowing through a body diode of the charging transistor CFET. When the discharging current flowing through the CFET is high enough, the power generated through the CFET can potentially over-heat or even damage the CFET. As discussed above and described in detail below, one solution that prevents the CFET from overheating is to turn the CFET ON when in a discharging condition.

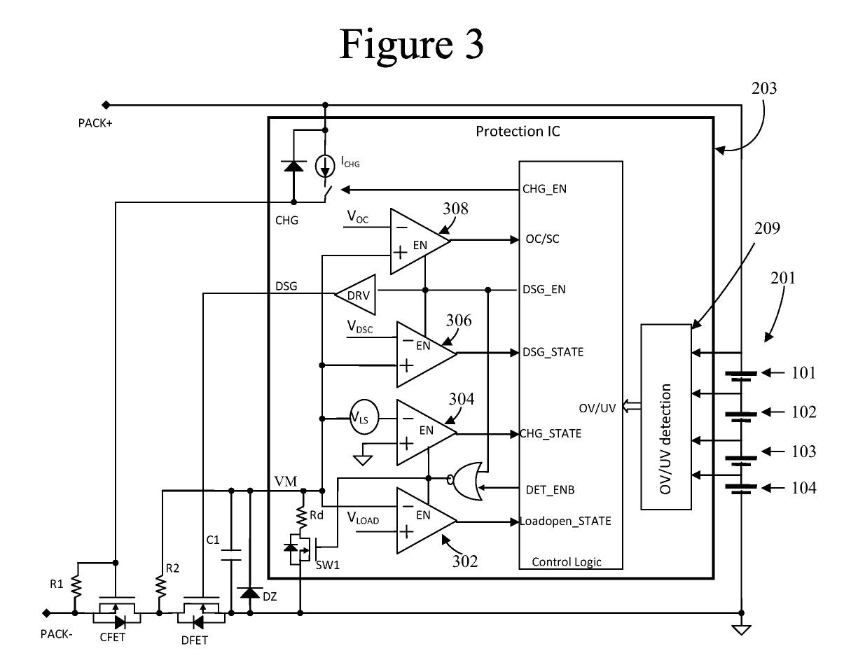

In FIG. 3, a battery protection IC block diagram is presented. The battery protection IC block diagram comprises a battery pack 201, comprising a plurality of battery modules 101-104 connected in parallel to a protection circuit 203, which may be then connected through PACK+/PACK− terminals to a load 205 (not shown) or a charger 207 (not shown). As illustrated in FIG. 3, many functions can be implemented through the VM pin. The VM pin is connected to a load open comparator 302, a charge state comparator 304, a discharge state comparator 306, and an over-current/short-circuit comparator 308.

A first function provided by the protection circuit 203 is the monitoring of a load state when under voltage (UV), over current (OC), or over temperature (OT) events occur. When a UV, OC or OT condition occurs, a first step is to determine whether or not a load 205 is still attached. In one exemplary embodiment, when a load 205 is determined to be attached to the battery pack 201, the load 205 must be removed before a charging or discharging condition is entered. As illustrated in FIG. 3, when the DFET enable signal DSG_EN is low and the DFET is off, and the NMOS switch SW1 is on, the VM pin will be pulled low if no load is connected with the PACK+/PACK− terminals. Under such conditions, the voltage of the VM pin will be an exemplary I_{CHG}*Rd, where I_{CHG} is the CHG pin current source and Rd is a pull-low resistor. In one exemplary embodiment the I_{CHG} is less than 10 μA and the Rd resistor is 10 kΩ. This exemplary VM voltage will be around 0.1V, which is much less than the predefined load-open reference voltage V_{LOAD}. An exemplary V_{LOAD} can be in the 1-2 Volt range, which can be implemented by the NMOS threshold.

However, if the load 205 is still connected, the PACK− terminal will be pulled high. The VM pin voltage will be around VM=(Vpack−V_{D})Rd/(R2+Rd). In one exemplary embodiment, the R2 value is relatively small and can be a few hundred ohms. A resistor R2 and a capacitor C1 provide a low pass filter. With a load 205 connected, the VM voltage will be close to the battery pack 201 voltage and much higher than the predefined reference voltage V_{LOAD} for load open detection. The load open comparator 302 will produce a high output, indicating that a load 205 is connected.

In one exemplary embodiment, in an effort to reduce the power consumption requirements while the DFET is OFF, especially in the under voltage (UV) mode and when no charger is plugged in, the load-open comparator 302 and the pull-down switch SW1 may be periodically turned ON with a very small on-duty duty cycle. For example, every 64 mS the load-open comparator 302 may be turned on for 2 mS to determine if a load is connected. In this way, when SW1 is OFF, the VM pin will have high impedance and the I_{CHG} current will not flow to ground and thus current consumption can be reduced.

A second function provided by the protection circuit 203 is the monitoring and response to an under-voltage (UV) condition as determined by the over-voltage/under-voltage detection module 209 of the protection circuit 203. As described above, when an under-voltage condition exists the DFET is OFF and the CFET is ON. When the DFET is OFF because of a UV condition, and the charger 207 is plugged in, the charger 207 will start to charge the battery pack 102. The charging current will go through the body diode of the DFET, with the power generated by the DFET defined by P_{D}=I_{CC}*V_{D}, where I_{CC} is a constant charging current and V_{D} is the DFET voltage diode voltage drop. For example, if I_{CC}=4 A and V_{D}=0.7V, then the DFET's power output will equal P_{D}=2.8 W, and may thus generate a lot of heat.

In order to prevent the DFET from heating during charging conditions, the DFET may be switched ON. As illustrated in FIG. 3, the charge state comparator 304 is used to monitor the charging condition. When a charger 207 is plugged in and starts charging, the VM pin voltage will be a negative V_{D}. As further illustrated in FIG. 3, the VM pin voltage is applied to a level shifter V_{LS} before it is applied to the inverting input of the charge state comparator 304. In an exemplary embodiment, the level shifter V_{LS} can shift the VM pin voltage (V_{D}) approximately +400 mV. When the VM pin voltage (V_{D}) is less than −V_{LS}, and thus still a voltage below 0 V, the charge-state comparator 304 will output a logic high to indicate it's in a charge state.

With the output of the charge state comparator 304 indicating that a charge condition exists, the control logic of the protection circuit 203 will enable the DFET by setting DSG_EN logic high. Once the DFET is turned ON, the VM pin voltage (V_{D}) will be close to 0 V and the charge state signal will also disappear. In one embodiment, before ending an under voltage (UV) condition, the DFET can be turned off for a small period of time so that the charge-state comparator can be enabled to check the charging condition. In a further exemplary embodiment, once a start state exists and a charger 207 has begun charging the battery pack 201, every 64 mS the over-voltage/under-voltage protection circuit 203 can turn the DFET OFF for 2 ms to check the current charging state. In this way, the DFET will not over-heat, but the current charging state may be periodically monitored.

A third function provided by the over-voltage/under-voltage detection module 209 of the protection circuit 203 is the monitoring and response to an over-voltage (OV) condition. As described above, when in a normal state or in an over voltage (OV) state, the DFET is kept ON and the CFET is turned OFF. In an over-voltage condition the charge state comparator 304 and the load open comparator 302 are disabled, while the discharge state comparator 306 and the OC/SC protection comparator 308 are enabled.

In an exemplary embodiment, when the DFET is ON, the DFET will have a small amount of internal resistance (Rds(on)). The voltage drop over the DFET's internal resistance can be measured at the VM pin. As discharge current flows through the body diode of the CFET, once a discharge circuit is activated, an increase in the discharge current can overheat or even damage the CFET.

Therefore, as illustrated in FIG. 3, a precision comparator, such as the discharge state comparator 306, can be used to compare a voltage drop over the DFET with a small reference V_{DSC}. The reference voltage V_{DSC} can be only a few millivolts since the internal resistance, Rds(on), of DFET will be small, which is in one exemplary embodiment, in the 10 mil range. When the VM pin voltage is higher than V_{DSC}, as determined by the discharge state comparator 306, a discharge state will be determined and the control logic of the over-voltage/under-voltage protection circuit 203 will enable the CFET. Otherwise it will keep the CFET off. In other words, in one exemplary embodiment, when either an over-voltage or normal state is present, (with the DFET switched ON and the CFET switched OFF) the discharge current is monitored by the discharge state comparator 306 (by comparing the VM pin voltage V_{D} to the reference voltage V_{DSC}) to ensure that the discharge current remains at a level where overheating or damaging the CFET can be avoided. When the discharge current increases across a threshold as determined by the discharge state comparator 306, then a discharge condition will exist and the CFET will be turned ON to avoid overheating or damaging the CFET.

A fourth function provided by the over-voltage/under-voltage detection module 209 of the protection circuit 203 is the monitoring for over current (OC) or short circuit (SC) conditions. When a large discharge current is present (as seen during a discharge condition), a positive voltage on the VM pin will exist and it will be equal to the voltage drop over the internal resistance of the DFET. As discussed above, during a discharge condition, the OC/SC comparator 308 is activated. If the VM pin voltage is higher than the over current (OC) threshold V_{OC}, as determined by the OC/SC comparator 308, it will trigger over-current/short-circuit (OC/SC) protections. In another embodiment, multiple level OC/SC protections can be used with a plurality of corresponding OC level references that are compared to the VM pin voltage (V_{D}).

A fifth function provided by the protection circuit 203 may be the monitoring for an over-temperature condition if there are charge over-temperature (COT) and/or discharge over-temperature (DOT) detections circuits available. In one embodiment, an over temperature comparator may be similar to the OC/SC comparator 308 with a OT threshold voltage compared to the VM pin voltage. If there is no over-temperature (OT) protection, or only a single fault over-temperature (OT) protection, the over-temperature comparator can be enabled only when an over-temperature state exists to save power. In another alternative, the over-temperature comparator can be periodically enabled.

As illustrated in FIG. 3, charging and discharging currents share a common path, but with different directions. In the charging state, the current flows from PACK+, through the battery cells, the DFET, and finally goes through the CFET and returns to PACK−. In the discharging state, the discharging current will flow out from the battery cells, and go to the load from PACK+. The discharging current will pass through the CFET first and then the DFET to return to the battery cell. As discussed above, in the charging state, the CFET must be on, if the DFET is off, the charging current will go through the body diode of the DFET.

Embodiments as discussed above, provided several advantages. Potential damage to the DFET during charging conditions is prevented by turning the DFET ON, while potential damage to the CFET during discharging conditions is prevented by turning the CFET ON. These embodiments also don't use a dedicated current sense resistor and can thus save overall system cost, thereby increasing the system efficiency as there would be no sensing resistor power loss. Lastly, these embodiments save on total IC pin count since no dedicated current sense pin is needed and thus a smaller package can be used.

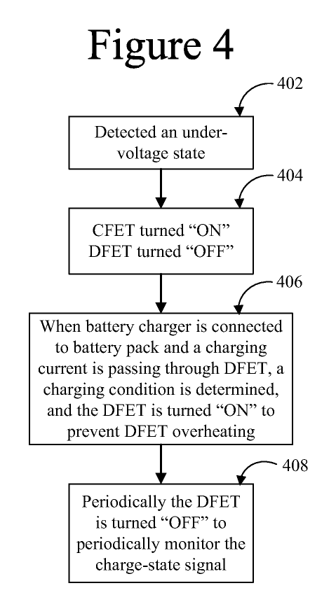

FIG. 4 illustrates the steps to a process for monitoring and responding to over-voltage and under-voltage conditions to determine charging conditions and discharging conditions. In step 402, an under-voltage state is detected by an over-voltage/under-voltage detection module 209 of the protection circuit 203. In step 404, the charge transistor (CFET) is turned ON and the discharge transistor (DFET) is turned OFF.

In step 406, when a charger 207 is connected to the battery 201 and a charging current is passing through the DFET, such that a charging condition exists as determined by a charging condition comparator, the DFET is turned ON to prevent the DFET from overheating. In one embodiment, before the charger 207 is connected to the battery 201, a detected load 205 is removed from the battery 201, as determined by a load open comparator 302. In step 408, when the DFET has been turned ON during a charging condition, the DFET is periodically turned OFF and back ON to allow the protection circuit 203 to monitor the charging conditions. In one exemplary embodiment, the DFET is turned OFF for 2 ms every 64 ms.

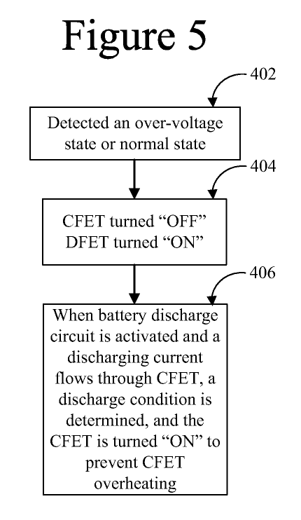

FIG. 5 illustrates the steps to a process for monitoring and responding to an over-voltage and under-voltage conditions to determine charging conditions and discharging conditions. In step 502, an over-voltage state is detected by an over-voltage/under-voltage detection module 209. In step 504, the charge transistor (CFET) is turned OFF and the discharge transistor (DFET) is turned ON.

In step 506, when a battery discharge circuit is activated and a discharging current is flowing through the CFET, such that a discharging condition exists as determined by a discharging condition comparator, the CFET is turned ON to prevent the CFET from overheating. In one embodiment, before the discharge circuit is activated, a detected load 205 is removed from the battery 201, as determined by a load open comparator 302.

Although certain preferred embodiments and methods have been disclosed herein, it will be apparent from the foregoing disclosure to those skilled in the art that variations and modifications of such embodiments and methods may be made without departing from the spirit and scope of the invention. It is intended that the invention shall be limited only to the extent required by the appended claims and the rules and principles of applicable law.

What is claimed is:

1. A battery charging/discharging apparatus comprising:
a battery comprising at least one battery module;
a charge transistor and a discharge transistor; and
an over-voltage/under-voltage protection circuit connected to the battery pack, the charge transistor, and the discharge transistor, wherein the over-voltage/under-voltage protection circuit controls the charging of the battery with the charge transistor and the discharging of the battery with the discharge transistor, wherein the charge transistor is ON and the discharge transistor is OFF when the battery, as determined by the over-voltage/under-voltage protection circuit, is in an under-voltage state, and wherein the discharge transistor is switched ON while still in the under-voltage state when a voltage between the charging transistor and the discharge transistor is less than a reference voltage as determined by a charging state comparator, when a charging circuit is charging the battery.

2. The battery charging/discharging apparatus of claim 1, wherein a charging condition exists when the voltage between the charging transistor and the discharging transistor is less than the reference voltage as determined by the charging state comparator.

3. The battery charging/discharging apparatus of claim 2, wherein the discharge transistor is periodically turned OFF and back ON again during a charging condition.

4. The battery charging/discharging apparatus of claim 3, wherein the discharge transistor is turned off for approximately 2 ms each periodic cycle.

5. The battery charging/discharging apparatus of claim 1, wherein the reference voltage is ground.

6. The battery charging/discharging apparatus of claim 1, wherein at least one of the charge transistor and discharge transistor is a field effect transistor (FET).

7. The battery charging/discharging apparatus of claim 1, wherein the discharge transistor is ON and the charge transistor is OFF when the battery, as determined by the over-voltage/under-voltage protection circuit, is in one of an over-voltage state and a normal state, and wherein the charge transistor is switched ON while still in the over-voltage or normal state when a voltage over the discharge transistor is higher than a discharge reference voltage, as determined by a discharging state comparator.

8. The battery charging/discharging apparatus of claim 1, further comprising a load open comparator for detecting the presence of a load by comparing a load open reference voltage to the voltage between the charging transistor and the discharge transistor, such that when a load is detected by the load open comparator, the load must be removed before charging can begin.

9. The battery charging/discharging apparatus of claim 7, further comprising an over-current/short-circuit comparator for detecting the presence of an over-current/short-circuit condition by comparing an over-current reference voltage to the voltage over the discharge transistor, wherein an over-current or short-circuit condition exists when the discharge transistor voltage is greater than the over-current reference voltage.

10. The battery charging/discharging apparatus of claim 1, wherein voltages to be compared to reference voltages in at least two of a load open comparator, a charge state comparator, a discharge state comparator, and a over current comparator are received by the over-voltage/under-voltage protection circuit at a single input to the over-voltage/under-voltage protection circuit.

11. A battery charging/discharging apparatus comprising:
a battery comprising at least one battery module;
a charge transistor and a discharge transistor; and
an over-voltage/under-voltage protection circuit connected to the battery pack, the charge transistor, and the discharge transistor, wherein the over-voltage/under-voltage protection circuit controls the charging of the battery with the charge transistor and the discharging of the battery with the discharge transistor, wherein the discharge transistor is ON and the charge transistor is OFF when the battery, as determined by the over-voltage/under-voltage protection circuit, is in one of an over-voltage state and a normal state, and wherein the charge transistor is switched ON while still in the over-voltage state or the normal state when a voltage over the discharge transistor is higher than a discharge reference voltage as determined by a discharging state comparator.

12. The battery charging/discharging apparatus of claim 11, wherein the charge transistor is ON and the discharge transistor is OFF when the battery, as determined by the over-voltage/under-voltage protection circuit, is in an under-voltage state, and wherein the discharge transistor is switched ON while still in the under-voltage state when an voltage between the charging transistor and the discharge transistor is less than a reference voltage as determined by a charging state comparator, when a charging circuit is charging the battery

13. The battery charging/discharging apparatus of claim 11, further comprising an over-current/short-circuit comparator for detecting the presence of an over-current/short-circuit condition by comparing an over-current reference voltage to the voltage over the discharge transistor, wherein an over-current or short-circuit condition exists when the discharge transistor voltage is greater than the over-current reference voltage.

14. The battery charging/discharging apparatus of claim 11, wherein at least one of the charge transistor and discharge transistor is a field effect transistor (FET).

15. The battery charging/discharging apparatus of claim 11, further comprising a load open comparator for detecting the presence of a load by comparing a load open reference voltage to the voltage between the charging transistor and the discharge transistor, such that when a load is detected by the load open comparator, the load must be removed before discharging can begin.

16. The battery charging/discharging apparatus of claim 11, wherein voltages to be compared to reference voltages in at least two of a load open comparator, a charge state comparator, a discharge state comparator, and a over current comparator are received by the over-voltage/under-voltage protection circuit at a single input to the over-voltage/under-voltage protection circuit.

17. A method for charging a battery pack comprising:
detecting an under-voltage state;
turning a charging transistor ON and turning a discharging transistor OFF, wherein the battery pack is charged through the charging transistor, and discharged through the discharging transistor;
charging the battery pack; and
turning the discharging transistor ON while still in the under-voltage state when a voltage between the charging transistor and the discharging transistor is less than a reference voltage.

18. The method of claim 17, wherein a charging condition exists when the voltage between the charging transistor and the discharging transistor is less than the reference voltage as determined by a charging state comparator.

19. The method of claim 18, wherein the discharge transistor is periodically turned OFF and back ON again during a charging condition.

20. The method of claim 19, wherein the discharge transistor is turned off for approximately 2 ms each periodic cycle.

21. The method of claim 17, wherein the reference voltage is ground.

22. The method of claim 17, wherein at least one of the charge transistor and discharge transistor is a field effect transistor (FET).

23. The method of claim 17, further comprising:
detecting one of an over-voltage state and a normal state;
turning a discharge transistor ON and turning a charge transistor OFF; and
turning the charge transistor ON while still in the over-voltage state or the normal state when a voltage over the discharge transistor is higher than a discharge reference voltage as determined by a discharging state comparator.

24. The method of claim 17, further comprising:
detecting the presence of a load attached to the battery by comparing a load open reference voltage to the voltage between the charging transistor and the discharge transistor, such that when a load is detected the load must be removed before charging can begin.

25. The method of claim 23, further comprising:
detecting the presence of an over-current/short-circuit condition by comparing an over-current reference voltage to the voltage over the discharge transistor, wherein an over-current or short-circuit condition exists when the discharge transistor voltage is greater than the over-current reference voltage.

26. The method of claim 17, wherein the under-voltage state, the normal state, and the over-voltage state are determined by an over-voltage/under-voltage protection circuit connected to the battery, the discharge transistor, and the charge transistor.
